(19) United States
(12) Patent Application Publication
(10) Pub. No.: US 2023/0112577 A1
(43) Pub. Date: Apr. 13, 2023

(54) ENERGY STORAGE DEVICE

(71) Applicant: GS Yuasa International Ltd., Kyoto-shi, Kyoto (JP)

(72) Inventors: Taisei SEKIGUCHI, Kyoto (JP); Yudai KAWASOE, Kyoto (JP)

(21) Appl. No.: 17/913,685

(22) PCT Filed: Mar. 18, 2021
(86) PCT No.: PCT/JP2021/010992

§ 371 Date: Sep. 22, 2022

(30) Foreign Application Priority Data
Mar. 25, 2020 (JP) 2020-054669

(51) Int. Cl. H01M 10/0587; H01M 50/103; H01M 50/183

(52) U.S. Cl. CPC H01M 10/0587; H01M 50/103; H01M 50/183

(57) ABSTRACT

One aspect of the present invention is an energy storage device including: a flattened electrode assembly formed by winding a belt-like electrode in a longitudinal direction thereof and including two curved surface portions and a flat portion located between the two curved surface portions; a case housing the electrode assembly; and a sheet-like member disposed between the electrode assembly and the case, in which when an inside of the case is in a negative pressure state, the electrode assembly is in a state of being pressed by the case with the sheet-like member interposed therebetween, and the sheet-like member is in contact only with the flat portion with respect to the electrode assembly.

### TECHNICAL FIELD

The present invention relates to an energy storage device.

### BACKGROUND ART

Chargeable and dischargeable energy storage devices (such as a secondary battery and a capacitor) are used for various devices such as mobile phones and electric vehicles. As the energy storage device, an energy storage device including an electrode assembly in which a positive electrode in which a positive active material layer is stacked on a surface of a positive electrode substrate and a negative electrode in which a negative active material layer is stacked on a surface of a negative electrode substrate are overlapped with each other with a separator having electrical insulation therebetween is widely used. Such an electrode assembly is housed together with an electrolyte such as an electrolyte solution in a case to configure an energy storage device.

In the energy storage device, it is known that a distance between the positive electrode and the negative electrode is shortened by compressing the electrode assembly to improve charge-discharge efficiency. As means for compressing the electrode assembly, a method of pressing from the outside of a case and a method of keeping the inside of the case at a negative pressure are known. Patent Document 1 describes a secondary battery adopting the latter method.

### PRIOR ART DOCUMENT

### Patent Document

Patent Document 1: JP-A-2013-98167

### SUMMARY OF THE INVENTION

### Problems to be Solved by the Invention

As a form of the electrode assembly of the energy storage device, a stacked electrode assembly formed by alternately stacking a plurality of positive electrodes and a plurality of negative electrodes with a separator interposed therebetween, and a wound electrode assembly formed by winding a belt-like positive electrode and a belt-like negative electrode in a state where the belt-like positive electrode and the belt-like negative electrode are stacked with a belt-like separator interposed therebetween are known. In general, in the case of a flattened wound electrode assembly, a curved surface portion where the positive electrode, the negative electrode, and the like are curved and stacked is thicker than a flat portion where the positive electrode, the negative electrode, and the like are flatly stacked. Thus, when the entire side surface of the flattened wound electrode assembly is pressed, a load is concentrated on the curved surface portion and the load on the flat portion becomes insufficient, which is not preferable. Here, in the case of the method of pressing from the outside of the case, it is relatively easy to adjust the magnitude of the load for each portion with respect to the electrode assembly by adjusting a pressing position, a pressing range, and the like. However, in the case of the method of keeping the inside of the case at a negative pressure, it is difficult to locally deform the case, and it is thus not easy to adjust the magnitude of the load for each portion with respect to the electrode assembly.

The present invention has been made in view of the above circumstances, and an object of the present invention is to provide an energy storage device in which a flattened wound electrode assembly is used and the inside of a case is in a negative pressure state, the energy storage device being capable of suppressing a load on a curved surface portion of the electrode assembly and applying a relatively large load to the flat portion of the electrode assembly.

### Means for Solving the Problems

One aspect of the present invention is an energy storage device including: a flattened electrode assembly formed by winding a belt-like electrode in a longitudinal direction thereof and including two curved surface portions and a flat portion located between the two curved surface portions; a case housing the electrode assembly; and a sheet-like member disposed between the electrode assembly and the case, in which when an inside of the case is in a negative pressure state, the electrode assembly is in a state of being pressed by the case with the sheet-like member interposed therebetween, and the sheet-like member is in contact only with the flat portion with respect to the electrode assembly.

### Advantages of the Invention

According to one aspect of the present invention, it is possible to provide an energy storage device in which a flattened wound electrode assembly is used and the inside of the case is in the negative pressure state, the energy storage device being capable of suppressing a load on the curved surface portion of the electrode assembly and applying a relatively large load to the flat portion of the electrode assembly.

### BRIEF DESCRIPTION OF THE DRAWINGS

FIG. 1 is a schematic perspective view illustrating an energy storage device according to a first embodiment of the present invention.

FIG. 2 is a schematic cross-sectional view taken along an arrow I-I of the energy storage device in FIG. 1.

FIG. 3 is a schematic cross-sectional view of an electrode assembly and a sheet-like member of the energy storage device in FIG. 1.

FIG. 4 is a schematic cross-sectional view of an energy storage device according to a second embodiment of the present invention.

FIG. 5 is a schematic view illustrating an energy storage apparatus configured by aggregating a plurality of the energy storage devices according to the first embodiment of the present invention.

### MODE FOR CARRYING OUT THE INVENTION

First, an outline of an energy storage device disclosed in the present specification will be described.

An energy storage device according to one aspect of the present invention is an energy storage device including: a flattened electrode assembly formed by winding a belt-like electrode in a longitudinal direction thereof and including two curved surface portions and a flat portion located between the two curved surface portions; a case housing the electrode assembly; and a sheet-like member disposed between the electrode assembly and the case, in which when an inside of the case is in a negative pressure state, the electrode assembly is in a state of being pressed by the case with the sheet-like member interposed therebetween, and the sheet-like member is in contact only with the flat portion with respect to the electrode assembly.

The energy storage device according to one aspect of the present invention is an energy storage device in which a flattened wound electrode assembly is used and the inside of the case is in the negative pressure state, the energy storage device being capable of suppressing a load on the curved surface portion of the electrode assembly and applying a relatively large load to the flat portion of the electrode assembly. Although the reason why such an effect is produced is not clear, the following reason is presumed. In the energy storage device according to one aspect of the present invention, the sheet-like member is disposed between the electrode assembly and the case, and the sheet-like member is in contact only with the flat portion with respect to the electrode assembly. That is, the sheet-like member is not in contact with the curved surface portion. Thus, since the inside of the case is in the negative pressure state, a load can be applied to the flat portion of the electrode assembly with the sheet-like member interposed therebetween in a state where the case is recessed. Even when the case is recessed and the case and the like are in direct contact with the curved surface portion of the electrode assembly, the load on the curved surface portion is weakened as compared with a case where the sheet-like member is not provided. Thus, it is presumed that in the energy storage device, concentration of a load on the curved surface portion of the electrode assembly can be alleviated, and a sufficient load can be applied to the flat portion.

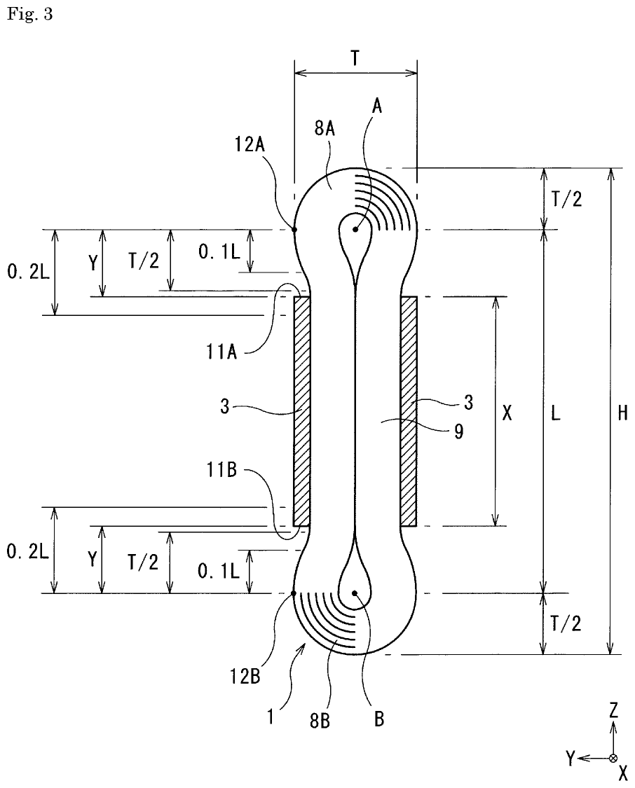

The “curved surface portion” of the electrode assembly refers to a substantially semicircular portion located at both ends as viewed in a winding axis direction, and specifically, when a thickness of the electrode assembly is defined as T, a region at both ends from both ends to a length T/2 as viewed in the winding axis direction is defined as the curved surface portion (see FIG. 3 and the like). The thickness T of the electrode assembly is the thickness of the thickest portion of the electrode assembly. Usually, a boundary between the curved surface portion and the flat portion is the thickest portion. The “flat portion” of the electrode assembly refers to a portion which is sandwiched between the two curved surface portions and is other than the two curved surface portions.

The fact that the inside of the case is in the “negative pressure state” means that an air pressure inside the case (pressure of a gas present inside the case) is lower than the air pressure outside the case (usually, atmospheric pressure). For example, when the case is recessed and a degree of the recess decreases when the case is opened from a sealed state, the inside of the case in the sealed state is in the negative pressure state.

In the energy storage device according to one aspect of the present invention, when the thickness of the electrode assembly is defined as T, both ends (both ends as viewed in the winding axis direction) of the sheet-like member in a opposing direction of the two curved surface portions are preferably present in a range inside a position on a T/2 inner side from both ends of the flat portion on the side of the two curved surface portions. Since a substantially semicircle having a radius of T/2 in a cross-sectional view is usually formed in the curved surface portion, the vicinity of both ends of the flat portion (portion adjacent to the curved surface portion) is also continuous with the substantially semicircle and relatively thick. Thus, by disposing the sheet-like member on the inner side further away from both ends of the flat portion even beyond a predetermined length (T/2), the load on the curved surface portion is further alleviated, and a relatively larger load can be applied to the flat portion.

In the energy storage device according to one aspect of the present invention, when a length in the opposing direction of the two curved surface portions of the flat portion is defined as L, both ends of the sheet-like member in the opposing direction of the two curved surface portions are preferably present in a range inside a position on a 0.1 L inner side from both ends of the flat portion on the side of the two curved surface portions. As described above, also by disposing the sheet-like member on the inner side further away from both ends of the flat portion even beyond a predetermined length (0.1 L), the load in the vicinity of both ends of the flat portion is alleviated, and a relatively larger load can be applied to the flat portion.

In the energy storage device according to one aspect of the present invention, when the length in the opposing direction of the two curved surface portions of the flat portion is defined as L, both ends of the sheet-like member in the opposing direction of the two curved surface portions are preferably each present in a range outside a position on a 0.2 L inner side from both ends of the flat portion on the side of the two curved surface portions. With such a configuration, the sheet-like member is disposed in a wide range of the flat portion to which a load is less likely to be applied, and the load can be relatively increased with respect to the wide range of the flat portion.

In the energy storage device according to one aspect of the present invention, a ratio of a thickness of the sheet-like member to the thickness of the electrode assembly is preferably 0.030 or more. When the thickness of the sheet-like member is 0.030 or more with respect to the thickness of the electrode assembly, the action obtained by disposing the sheet-like member is particularly sufficiently exerted, a load on the curved surface portion of the electrode assembly can be further suppressed, and a relatively larger load can be applied to the flat portion of the electrode assembly.

The thickness of the sheet-like member is an average value of measured values at arbitrary five points. When a plurality of sheet-like members are provided, for example, when the sheet-like members are provided on one surface of the flat portion of the electrode assembly or when the sheet-like members are provided on both surfaces of the flat portion of the electrode assembly, a sum of the thicknesses of all the sheet-like members is defined as the thickness of the sheet-like member.

In the energy storage device according to one aspect of the present invention, it is preferable that the case includes metal, an insulating member which covers the electrode assembly and insulates the electrode assembly and the case from each other is included, and the sheet-like member is disposed between the electrode assembly and the insulating member. In such an aspect, it is possible to suppress a load on the curved surface portion of the electrode assembly and apply a relatively large load to the flat portion of the electrode assembly while securing insulation between the case and the electrode assembly by the insulating member.

Hereinafter, an energy storage device according to an embodiment of the present invention will be described in detail.

### Energy Storage Device: First Embodiment

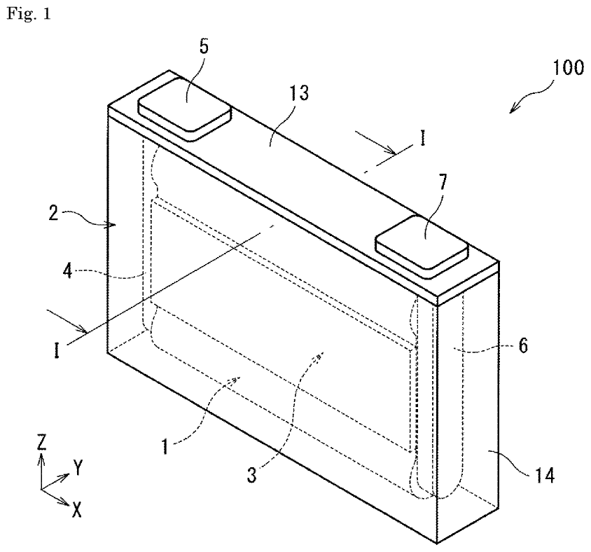

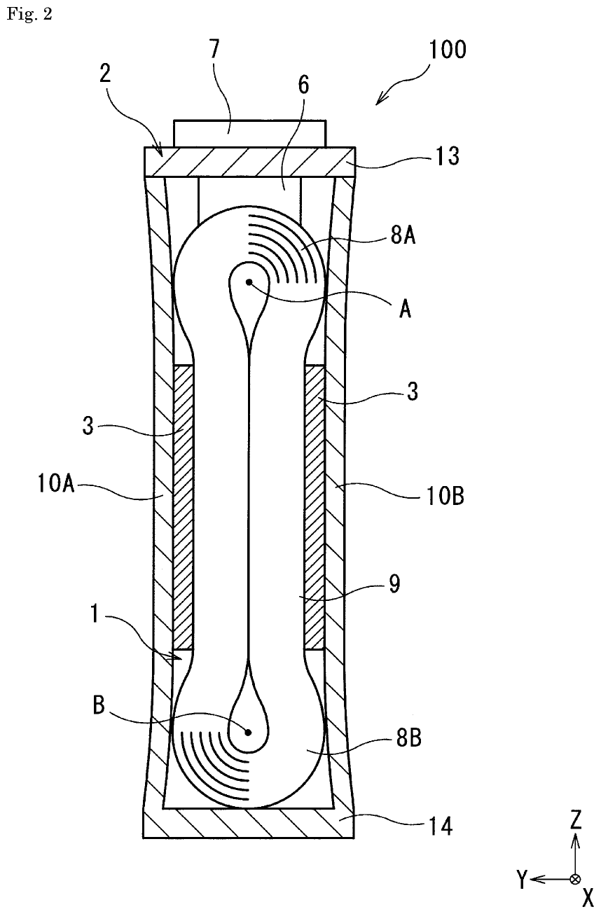

An energy storage device 100 (secondary battery) according to a first embodiment of the present invention illustrated in FIGS. 1 and 2 mainly includes an electrode assembly 1, a case 2, two sheet-like members 3, and an electrolyte (not illustrated). The electrode assembly 1, the sheet-like member 3, and the electrolyte are housed in a sealed state in the case 2. The energy storage device 100 further includes a positive electrode connecting member 4, a positive electrode external terminal 5, a negative electrode connecting member 6, and a negative electrode external terminal 7. The electrode assembly 1 includes a positive electrode, a negative electrode, and a separator as described later. The positive electrode of the electrode assembly 1 is electrically connected to the positive electrode external terminal 5 with the positive electrode connecting member 4 interposed therebetween. The negative electrode of the electrode assembly 1 is electrically connected to the negative electrode external terminal 7 with the negative electrode connecting member 6 interposed therebetween.

The electrode assembly 1 is a wound electrode assembly formed by winding belt-like electrode in a longitudinal direction of the belt-like electrode. The belt-like electrode includes a belt-like positive electrode and a belt-like negative electrode. A belt-like separator is interposed between the belt-like positive electrode and the belt-like negative electrode. That is, the electrode assembly 1 is formed by winding the belt-like positive electrode and the belt-like negative electrode in the longitudinal direction in a state where the belt-like positive electrode and the belt-like negative electrode are overlapped with each other with the belt-like separator interposed therebetween.

The electrode assembly 1 is a flattened wound electrode assembly. The electrode assembly 1 may have a configuration and a shape similar to those of a conventionally known flattened wound electrode assembly. As illustrated in FIGS. 2 and 3, the electrode assembly 1 includes two curved surface portions 8A and 8B and a flat portion 9. The electrode assembly 1 has a substantially rectangular shape in plan view (Y direction view: thickness direction view).

The curved surface portions 8A and 8B have a substantially semi-cylindrical shape in a state where the positive electrode, the negative electrode, and the separator are wound around the axes A and B. That is, the curved surface portions 8A and 8B have a substantially semicircular shape in which the outer side (upper and lower sides in FIGS. 2 and 3) is an arc as viewed in the winding axis direction (X direction view: state of FIGS. 2 and 3).

The flat portion 9 is located between the two curved surface portions 8A and 8B. In the flat portion 9, the positive electrode, the negative electrode, and the separator are overlapped substantially in parallel. However, both ends (upper end and lower end in FIGS. 2 and 3) of the flat portion 9 as viewed in the winding axis direction (as viewed in the X direction) are connected to the curved surface portions 8A and 8B thicker than the flat portion 9, and thus may be slightly curved.

The size of the electrode assembly 1 is not particularly limited. The thickness T of the electrode assembly 1 can be, for example, 5 mm or more and 30 mm or less. A length H (H=L+T) of the electrode assembly 1 in an opposing direction (Z direction) of the two curved surface portions 8A and 8B can be, for example, 30 mm or more and 300 mm or less. A width (length in a direction perpendicular to the opposing direction of the two curved surface portions 8A and 8B and the thickness direction; length in the X direction) of the electrode assembly 1 can be, for example, 30 mm or more and 300 mm or less. A length L of the flat portion 9 of the electrode assembly 1 in the opposing direction (Z direction) of the two curved surface portions 8A and 8B can be, for example, 20 mm or more and 200 mm or less. A ratio (H/T) of the length H in the opposing direction (Z direction) of the two curved surface portions 8A and 8B to the thickness T of the electrode assembly 1 can be, for example, 3 or more and 20 or less. Hereinafter, basically in each constituent element, a distance in the Z direction in each drawing is defined as a length, and a distance in the X direction in each drawing is defined as a width.

The case 2 is a sealed case which houses the electrode assembly 1 and the like and in which an electrolyte is enclosed. The material of the case 2 may be, for example, a resin such as polyolefin or polyamide or a metal such as aluminum or stainless steel as long as the material has sealability capable of enclosing an electrolyte and strength capable of protecting the electrode assembly 1.

The case 2 is a flat prismatic case corresponding to the shape of the electrode assembly 1. The case 2 includes a lid 13 and a case body 14. The case body 14 includes a pair of side walls 10A and 10B parallel to both surfaces of the flat portion 9 of the electrode assembly 1. The inside of the case 2 is in a negative pressure state. Thus, the side walls 10A and 10B are pushed by the atmospheric pressure from the outside and are slightly recessed. That is, the side walls 10A and 10B are slightly curved to protrude inward. In a state where the side walls 10A and 10B are not recessed, the case 2 and the case body 14 have a substantially rectangular parallelepiped shape.

The degree of the air pressure inside the case 2 is not particularly limited as long as it is lower than the air pressure (atmospheric pressure) outside the case 2 to such an extent that the side walls 10A and 10B are recessed, and a difference between the air pressure inside the case 2 and the air pressure outside the case 2 can be, for example, 5 kPa or more and 95 kPa or less, may be 10 kPa or more and 90 kPa or less, and is preferably 20 kPa or more and 80 kPa or less. When the difference between the air pressure inside the case 2 and the air pressure outside the case 2 is equal to or greater than the lower limit, a pressing force of the electrode assembly 1 by the case 2 can be improved. The air pressure in the case 2 can be, for example, 5 kPa or more and 95 kPa or less, may be 10 kPa or more and 90 kPa or less, and is preferably 20 kPa or more and 80 kPa or less. However, the air pressure in the case 2 can be appropriately set according to the thickness, material, and the like of the side walls 10A and 10B. The thickness of the side walls 10A and 10B can be, for example, 0.1 mm or more and 1 mm or less. The side walls 10A and 10B may have a substantially uniform thickness. An inner dimension of the case 2 may be a size into which the electrode assembly 1 can be inserted, and the inner dimension in the thickness direction (Y direction) may be substantially the same as the thickness T of the electrode assembly 1.

The sheet-like member 3 is disposed between the electrode assembly 1 and the case 2. The sheet-like member 3 is disposed between the electrode assembly 1 and the side wall 10A and between the electrode assembly 1 and the side wall 10B. The sheet-like member 3 is in contact with only the flat portion 9 with respect to the electrode assembly 1, and is not in contact with the curved surface portions 8A and 8B. In other words, the sheet-like member 3 is disposed in the flat portion 9 of the electrode assembly 1 as viewed in the thickness direction (as viewed in the Y direction). That is, the sheet-like member 3 is not disposed on the curved surface portions 8A and 8B of the electrode assembly 1 as viewed in the thickness direction. The sheet-like member 3 may not be fixed to the flat portion 9 or the side walls 10A and 10B, or may be fixed with an adhesive or the like.

Since the inside of the case 2 is in the negative pressure state, the side walls 10A and 10B are recessed. One surface (inner surface) of the sheet-like member 3 is in contact with a surface of the flat portion 9 of the electrode assembly 1, and the other surface (outer surface) of the sheet-like member 3 is in contact with the inner surfaces of the side walls 10A and 10B. Thus, the flat portion 9 of the electrode assembly 2 is in a state of being pressed by the side walls 10A and 10B of the case 2 with the sheet-like member 3 interposed therebetween. That is, in the energy storage device 100, since the sheet-like member 3 is disposed, it is possible to usually suppress the load on the curved surface portions 8A and 8B on which the load is concentrated and to usually relatively increase the load on the flat portion 9 on which the load is less likely to be applied. As a result, in the energy storage device 100, the load applied to the side surface of the electrode assembly 1 can be made uniform.

The sheet-like member 3 has a rectangular shape in plan view (Y direction view). In plan view, each side of the sheet-like member 3 is disposed so as to be substantially parallel to each side of the electrode assembly 1. A width (length in the X direction) of the sheet-like member 3 may be equal to or slightly shorter than the width (length in the X direction) of the electrode assembly 1.

As illustrated in FIG. 3 and the like, a length X (length in the Z direction) of the sheet-like member 3 is shorter than the length L (length in the Z direction) of the flat portion 9 of the electrode assembly 1. With regard to the relationship between the length X of the sheet-like member 3 and the length L of the flat portion 9, positions of both ends in the Z direction of the sheet-like member 3, that is, both ends in the opposing direction of the two curved surface portions 8A and 8B (hereinafter, both ends are also simply referred to as “both ends 11A and 11B”) of the sheet-like member 3 will be described.

Both ends 11A and 11B of the sheet-like member 3 are preferably present in a range inside a position on a T/2 inner side from both ends 12A and 12B on the side of the two curved surface portions 8A and 8B of the flat portion 9 of the electrode assembly 1. That is, a distance Y from both ends 12A and 12B of the flat portion 9 to both ends 11A and 11B of the sheet-like member 3 is preferably larger than T/2. Note that T is the thickness of the electrode assembly 1, and the curved surface portions 8A and 8B form a substantially semicircle having a radius T/2 as viewed in the winding axis direction (as viewed in the X direction). By disposing the sheet-like member 3 on the inner side further away from both ends 12A and 12B of the flat portion 9 even beyond a predetermined length (T/2), the sheet-like member 3 is disposed at a portion having a particularly small thickness in the flat portion 9, so that the load on the curved surface portions 8A and 8B and the vicinity thereof is alleviated, and the load on the flat portion 9 of the electrode assembly 1 can be relatively increased.

From the same viewpoint, it is preferable that both ends 11A and 11B of the sheet-like member 3 are present in a range inside a position on a 0.1 L inner side from both ends 12A and 12B on the side of the two curved surface portions 8A and 8B of the flat portion 9 of the electrode assembly 1. That is, the distance Y from both ends 12A and 12B of the flat portion 9 to both ends 11A and 11B of the sheet-like member 3 is preferably larger than 0.1 L. Note that L is the length of the flat portion 9 in the opposing direction (Z direction) of the two curved surface portions 8A and 8B.

On the other hand, it is preferable that both ends 11A and 11B of the sheet-like member 3 are present in a range outside a position on a 0.2 L inner side from both ends 12A and 12B on the side of the two curved surface portions 8A and 8B of the flat portion 9 of the electrode assembly 1. That is, the distance Y from both ends 12A and 12B of the flat portion 9 to both ends 11A and 11B of the sheet-like member 3 is preferably less than 0.2 L. With such a configuration, the sheet-like member 3 can be disposed in a wide range of the flat portion 9, and the load can be relatively increased with respect to the wide range of the flat portion 9.

From the above, the length X (length in the Z direction) of the sheet-like member 3 is preferably more than 0.6 L and less than L-T, and also preferably more than 0.6 L and less than 0.8 L.

A ratio of a total thickness of the plurality of sheet-like members 3 to the thickness T of the electrode assembly may be, for example, 0.020 or more, is preferably 0.030 or more, and more preferably 0.035 or more. When the total thickness of the plurality of sheet-like members 3 is equal to or greater than the lower limit with respect to the thickness T of the electrode assembly 1, a more sufficient load can be applied to the flat portion 9. The upper limit of the ratio of the total thickness of the plurality of sheet-like members 3 to the thickness T of the electrode assembly may be, for example, 0.2 or 0.1. The thickness of one sheet-like member 3 is not particularly limited, and can be, for example, 0.1 mm or more and 2 mm or less.

The thickness of the sheet-like member 3 is preferably substantially uniform. When the thickness of the sheet-like member 3 is substantially uniform, the load can be uniformly applied to the flat portion 9, and, in addition, the electrode assembly 1 and the sheet-like member 3 can be easily inserted into the case 2.

The material of the sheet-like member 3 is not particularly limited, and may be made of resin, metal, other inorganic materials, or the like, or may be formed from a plurality of members or materials. The sheet-like member 3 is usually an insulating (non-conductive) sheet. From the viewpoint of handleability and the like, the sheet-like member 3 is preferably made of resin. Examples of the resin configuring the sheet-like member 3 include polyolefins such as polyethylene and polypropylene, polyimide, and aramid. Each of the sheet-like members 3 disposed on each surface of the flat portion 9 may be formed by stacking a plurality of sheets.

Hereinafter, each constituent element other than the sheet-like member 3 will be described in detail.

### (Positive Electrode)

The positive electrode which is one of the belt-like electrodes includes a positive electrode substrate and a positive active material layer stacked on the positive electrode substrate directly or with an intermediate layer interposed therebetween.

The positive electrode substrate has conductivity. Having “conductivity” means having a volume resistivity of 10⁷ Ω-cm or less that is measured in accordance with JIS-H-0505 (1975), and the term “non-conductivity” means that the volume resistivity is more than 10⁷ Ω-cm. As the material of the positive substrate, a metal such as aluminum, titanium, tantalum or stainless steel, or an alloy thereof is used. Among these materials, aluminum and aluminum alloys are preferable from the viewpoint of the balance among electric potential resistance, high conductivity, and cost. Examples of the form of formation of the positive substrate include a foil and a vapor deposition film, and a foil is preferred from the viewpoint of cost. More specifically, an aluminum foil is preferable as the positive substrate. Examples of the aluminum or aluminum alloy include A1085 and A3003 prescribed in JIS-H-4000 (2014).

The positive electrode substrate may be a substrate (plate, sheet) having a substantially uniform thickness. The average thickness of the positive electrode substrate is preferably 3 μm or more and 50 μm or less, more preferably 5 μm or more and 40 μm or less, still more preferably 8 μm or more and 30 μm or less, and particularly preferably 10 μm or more and 25 μm or less. When the average thickness of the positive electrode substrate is within the above-described range, it is possible to enhance the energy density per volume of the energy storage device 100 while increasing the strength of the positive electrode substrate. The “average thickness” of the positive electrode substrate and the negative electrode substrate described below refers to a value obtained by dividing a cutout mass in cutout of a substrate having a predetermined area by a true density and a cutout area of the substrate.

The intermediate layer is a coating layer on the surface of the positive substrate, and contains conductive particles such as carbon particles to reduce contact resistance between the positive substrate and the positive active material layer. The configuration of the intermediate layer is not particularly limited, and can be formed from, for example, a composition containing a resin binder and conductive particles.

The positive active material layer is a layer including a positive active material. The positive active material layer contains optional components such as a conductive agent, a binder (binding material), a thickener and a filler as necessary.

The positive active material can be appropriately selected from known positive active materials. As the positive active material for a lithium ion secondary battery, a material capable of storing and releasing lithium ions is usually used. Examples of the positive active material include lithium-transition metal composite oxides having an α-NaFeO₂-type crystal structure, lithium-transition metal composite oxides having a spinel-type crystal structure, polyanion compounds, chalcogenides, and sulfur. Examples of the lithium transition metal composite oxide having an α-NaFeO₂-type crystal structure include Li[LiₓNi₁₋ₓ]O₂ (0≤x<0.5), Li[LiₓNi_{γ}Co_{1-x-γ}]O₂ (0≤x<0.5, 0<γ<1), Li[LiₓCo₁₋ₓ]O₂ (0≤x<0.5), Li[LiₓNi_{γ}Mn_{1-x-γ}]O₂ (0≤x<0.5, 0<γ<1), Li[LiₓNi_{γ}Mn_{β}Co_{1-x-γ-β}]O₂ (0≤x<0.5, 0<γ, 0<β, 0.5<γ+β<1), and Li[LiₓNi_{γ}Co_{β}Al_{1-x-γ-β}]O₂ (0≤x<0.5, 0<γ, 0<β, 0.5<γ+β<1). Examples of the lithium-transition metal composite oxides having a spinel-type crystal structure include LiₓMn₂O₄ and LiₓNi_{γ}Mn_{2-γ}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. Apart of atoms or polyanions in these materials may be substituted with atoms or anion species composed of other elements. The surfaces of these materials may be coated with other materials. In the positive active material layer, one of these materials may be used singly, or two or more thereof may be used in mixture.

The positive active material is usually particles (powder). The average particle size of the positive active material is preferably 0.1 μm or more and 20 μm or less, for example. By setting the average particle size of the positive active material to be equal to or greater than the lower limit, the positive active material is easily manufactured or handled. By setting the average particle size of the positive active material to be equal to or less than the upper limit, the electron conductivity of the positive active material layer is improved. It is to be noted that in the case of using a composite of the positive active material and another material, the average particle size of the composite is regarded as the average particle size of the positive active material. The term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher, a classifier, and the like are used to obtain a powder that has a predetermined particle size. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner.

The content of the positive active material in the positive active material layer is preferably 50% by mass or more and 99% by mass or less, more preferably 70% by mass or more and 98% by mass or less, and still more preferably 80% by mass or more and 95% by mass or less. When the content of the positive active material is in the above range, it is possible to achieve both high energy density and productivity of the positive active material layer.

The conductive agent is not particularly limited as long as it is a material exhibiting conductivity. Examples of such a conductive agent include carbonaceous materials, metals, and conductive ceramics. Examples of the carbonaceous materials include graphitized carbon, non-graphitized carbon, and graphene-based carbon. Examples of the non-graphitized carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the shape of the conductive agent include a powdery shape and a fibrous shape. As the conductive agent, one of these materials may be used singly, or two or more thereof may be mixed and used. These materials may be composited and used. For example, a material obtained by compositing carbon black with CNT may be used. Among these materials, carbon black is preferable from the viewpoint of electron conductivity and coatability, and in particular, acetylene black is preferable.

The content of the conductive agent in the positive active material layer is preferably 1% by mass or more and 10% by mass or less, more preferably 3% by mass or more and 9% by mass or less. When the content of the conductive agent falls within the above range, the energy density of the energy storage device 100 can be enhanced.

Examples of the binder include: thermoplastic resins such as fluororesin (polytetrafluoroethylene (PTFE), polyvinylidene fluoride (PVDF), etc.), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 1% by mass or more and 10% by mass or less, more preferably 2% by mass or more and 9% by mass or less, still more preferably 3% by mass or more and 6% by mass or less. By setting the content of the binder in the above range, the active material can be stably held.

Examples of the thickener include polysaccharide polymers such as carboxymethylcellulose (CMC) and methylcellulose. When the thickener has a functional group that is reactive with lithium and the like, the functional group may be deactivated by methylation or the like in advance. In the case of using a thickener, the content of the thickener in the positive active material layer 12 can be 0.1% by mass or more and 8% by mass or less, and is typically preferably 5% by mass or less, more preferably 2% by mass or less. The technique disclosed herein can be preferably carried out in an aspect in which the positive active material layer contains no thickener.

The filler is not particularly limited. Examples of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof. In the case of using a filler, the content of the filler in the positive active material layer can be 0.1% by mass or more and 8% by mass or less, and is typically preferably 5% by mass or less, more preferably 2% by mass or less. The technique disclosed herein can be preferably carried out in an aspect in which the positive active material layer does not contain a filler.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material, the conductive agent, the binder, the thickener, and the filler.

### (Negative Electrode)

The negative electrode which is the other belt-like electrode includes a negative electrode substrate and a negative active material layer stacked on the negative electrode substrate directly or with an intermediate layer interposed therebetween. The configuration of the intermediate layer, which may be provided for the negative electrode, is not particularly limited, and for example can be selected from the configurations exemplified for the positive electrode.

Although the negative electrode substrate may have the same configuration as that of the positive electrode substrate, as the material, metals such as copper, nickel, stainless steel, and nickel-plated steel or alloys thereof are used, and copper or a copper alloy is preferable. More specifically, the negative substrate is preferably a copper foil. Examples of the copper foil include a rolled copper foil and an electrolytic copper foil.

The negative electrode substrate may be a substrate (plate, sheet) having a substantially uniform thickness. The average thickness of the negative electrode substrate is preferably 2 μm or more and 35 μm or less, more preferably 3 μm or more and 30 μm or less, still more preferably 4 μm or more and 25 μm or less, and particularly preferably 5 μm or more and 20 μm or less. When the average thickness of the negative substrate falls within the above-described range, it is possible to increase the energy density per volume of the energy storage device 100 while increasing the strength of the negative substrate.

The negative active material layer is a layer including a negative active material. The negative active material layer contains optional components such as a conductive agent, a binder, a thickener, and a filler, if necessary. As the optional components such as a conductive agent, a binder, a thickener, and a filler, the same components as those in the positive active material layer can be used.

The negative active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

The negative active material can be appropriately selected from known negative active materials. For example, as the negative active material for a lithium ion secondary battery, a material capable of occluding and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). In the negative active material layer, one of these materials may be used singly, or two or more of these materials may be used in mixture.

The term “graphite” refers to a carbon material in which an average grid distance (d₀₀₂) of a (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average lattice distance (d₀₀₂) of the (002) plane determined by the X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

Here, the “discharged state” of the carbon material refers to a state where an open circuit voltage is 0.7 V or more in a half cell using a negative electrode, containing a carbon material as a negative active material, as a working electrode and using metallic Li as a counter electrode. Since the potential of the metal Li counter electrode in an open circuit state is substantially equal to an oxidation/reduction potential of Li, the open circuit voltage in the half cell is substantially equal to the potential of the negative electrode containing the carbon material with respect to the oxidation/reduction potential of Li. More specifically, the fact that the open circuit voltage in the half cell is 0.7 V or more means that lithium ions that can be occluded and released in association with charge-discharge are sufficiently released from the carbon material that is the negative active material.

The “hardly graphitizable carbon” refers to a carbon material in which the d₀₀₂ is 0.36 nm or more and 0.42 nm or less.

The “easily graphitizable carbon” refers to a carbon material in which the d₀₀₂ is 0.34 nm or more and less than 0.36 nm.

When the form of the negative active material is a particle (powder), an average particle size of the negative active material can be, for example, 1 nm or more and 100 μm or less. When the negative active material is, for example, a carbon material, the average particle size thereof may be preferably 1 μm or more and 100 μm or less. When the negative active material is a metal, a metalloid, a metal oxide, a metalloid oxide, a titanium-containing oxide, a polyphosphoric acid compound or the like, the average particle size thereof may be preferably 1 nm or more and 1 μm or less. By setting the average particle size of the negative active material to be equal to or greater than the lower limit, the negative active material is easily produced or handled. By setting the average particle size of the negative active material to be equal to or less than the upper limit, the electron conductivity of the active material layer is improved. A crusher, a classifier, and the like are used to obtain a powder that has a predetermined particle size. When the negative active material is metallic Li, the form may be foil-shaped or plate-shaped.

The content of the negative active material in the negative active material layer is preferably 60% by mass or more and 99% by mass or less, and more preferably 90% by mass or more and 98% by mass or less. When the content of the negative active material falls within the above range, it is possible to achieve both high energy density and productivity of the negative active material layer. Further, when the negative active material is metal Li, the content of the negative active material in the negative active material layer may be 99% by mass or more, and may be 100% by mass.

### (Separator)

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining property of the electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles included in the heat resistant layer preferably have a mass loss of 5% or less in the case of heating from room temperature to 500° C. under the atmosphere, and more preferably have a mass loss of 5% or less in the case of heating from room temperature to 800° C. under the atmosphere. Inorganic compounds can be mentioned as materials whose mass loss is less than or equal to a predetermined value when the materials are heated. Examples of the inorganic compound include: oxides such as iron oxide, silicon oxide, aluminum oxide, titanium oxide, zirconium oxide, calcium oxide, strontium oxide, barium oxide, magnesium oxide, and aluminosilicate; hydroxides such as magnesium hydroxide, calcium hydroxide, and aluminum hydroxide; nitrides such as aluminum nitride and silicon nitride; carbonates such as calcium carbonate; sulfates such as barium sulfate; hardly soluble ionic crystals such as calcium fluoride, barium fluoride, and barium titanate; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compound, a simple substance or a complex of these substances may be used alone, or two or more thereof may be mixed and used. Among these inorganic compounds, silicon oxide, aluminum oxide, or aluminosilicate is preferable from the viewpoint of safety of the energy storage device.

The porosity of the separator is preferably 80% by volume or less from the viewpoint of strength, and is preferably 20% by volume or more from the viewpoint of discharge performance. The term “porosity” herein is a volume-based value, and means a value measured with a mercury porosimeter.

As the separator, a polymer gel composed of a polymer and an electrolyte may be used. Examples of the polymer include polyacrylonitrile, polyethylene oxide, polypropylene oxide, polymethyl methacrylate, polyvinyl acetate, polyvinylpyrrolidone, and polyvinylidene fluoride. The use of the polymer gel has the effect of suppressing liquid leakage. As the separator, a polymer gel may be used in combination with a porous resin film, a nonwoven fabric, or the like as described above.

### (Electrolyte)

The electrolyte can be appropriately selected from known electrolytes. As the electrolyte, an electrolyte solution can be used, and in particular, a nonaqueous electrolyte solution may be used. The nonaqueous electrolyte solution contains a nonaqueous solvent and an electrolyte salt dissolved in the nonaqueous solvent. As described later, in a production process, a gas dissolved in the nonaqueous electrolyte solution together with the nonaqueous electrolyte solution is enclosed in the case and hermetically sealed, so that the inside of the case can be brought into the negative pressure state. Thus, the nonaqueous electrolyte solution may contain a component (for example, carbon dioxide or the like) that is enclosed in the case in a gaseous state and dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these examples, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these examples, DMC and EMC are preferable.

As the nonaqueous solvent, it is preferable to use at least one of the cyclic carbonate and the chain carbonate, and it is more preferable to use the cyclic carbonate and the chain carbonate in combination. By using the cyclic carbonate, dissociation of the electrolyte salt can be promoted to improve the ionic conductivity of the nonaqueous electrolyte solution. By using the chain carbonate, the viscosity of the nonaqueous electrolyte solution can be kept low. When the cyclic carbonate and the chain carbonate are used in combination, a volume ratio of the cyclic carbonate to the chain carbonate (cyclic carbonate:chain carbonate) is preferably in a range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these salts, the lithium salt is preferable.

Examples of the lithium salt include inorganic lithium salts such as LiPF₆, LiPO₂F₂, LiBF₄, LiClO₄, and LiN(SO₂F)₂, and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these salts, an inorganic lithium salt is preferable, and LiPF₆ is more preferable.

The content of the electrolyte salt in the nonaqueous electrolyte solution is preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, and particularly preferably 0.7 mol/dm³ or more and 1.5 mol/dm³ or less. The content of the electrolyte salt falls within the above range, thereby allowing the ionic conductivity of the nonaqueous electrolyte solution to be increased.

The nonaqueous electrolyte solution may contain an additive. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; succinic anhydride, glutaric anhydride, maleic anhydride, citraconic anhydride, glutaconic anhydride, itaconic anhydride, and cyclohexanedicarboxylic anhydride; ethylene sulfite, propylene sulfite, dimethyl sulfite, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, and tetrakistrimethylsilyl titanate. These additives may be used singly, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, and particularly preferably 0.3% by mass or more and 3% by mass or less, with respect to a total mass of the nonaqueous electrolyte solution. When the content of the additive falls within the above range, it is possible to improve capacity retention performance or charge-discharge cycle performance after high-temperature storage, and to further improve safety.

As the electrolyte, a solid electrolyte may be used, or a nonaqueous electrolyte solution and a solid electrolyte may be used in combination. Furthermore, as the electrolyte, an electrolyte solution with water as a solvent may be used.

The solid electrolyte can be selected from any material having ionic conductivity such as lithium, sodium and calcium and being solid at normal temperature (for example, 15° C. to 25° C.). Examples of the solid electrolyte include sulfide solid electrolytes, oxide solid electrolytes, oxynitride solid electrolytes, and polymer solid electrolytes.

Examples of the lithium ion secondary battery include Li₂S—P₂S₅, LiI—Li₂S—P₂S₅, and Li₁₀Ge—P₂S₁₂ as the sulfide solid electrolyte.

### (Production Method)

The energy storage device 100 can be produced by a production method including, for example, fabricating a wound flattened electrode assembly, preparing a sheet-like member, housing the electrode assembly and the sheet-like member in a case, injecting an electrolyte into the case, and hermetically sealing the case. The electrode assembly can be produced by the same method as the conventionally known wound electrode assembly.

In order to produce the energy storage device 100 in which the inside of the case 2 is in the negative pressure state, a gas (for example, carbon dioxide or the like) dissolved in an electrolyte such as a nonaqueous electrolyte solution may be enclosed in the case 2 to hermetically seal the case 2. With such a configuration, the gas is dissolved in the electrolyte in the state where the case 2 is hermetically sealed, the air pressure inside the case 2 is lowered, and the energy storage device 100 in which the inside of the case 2 is in the negative pressure state can be obtained. In addition, the energy storage device 100 in which the inside of the case 2 is in the negative pressure state can also be obtained by injecting an electrolyte into the case 2 under low pressure and hermetically sealing the case 2.

### Energy Storage Device: Second Embodiment

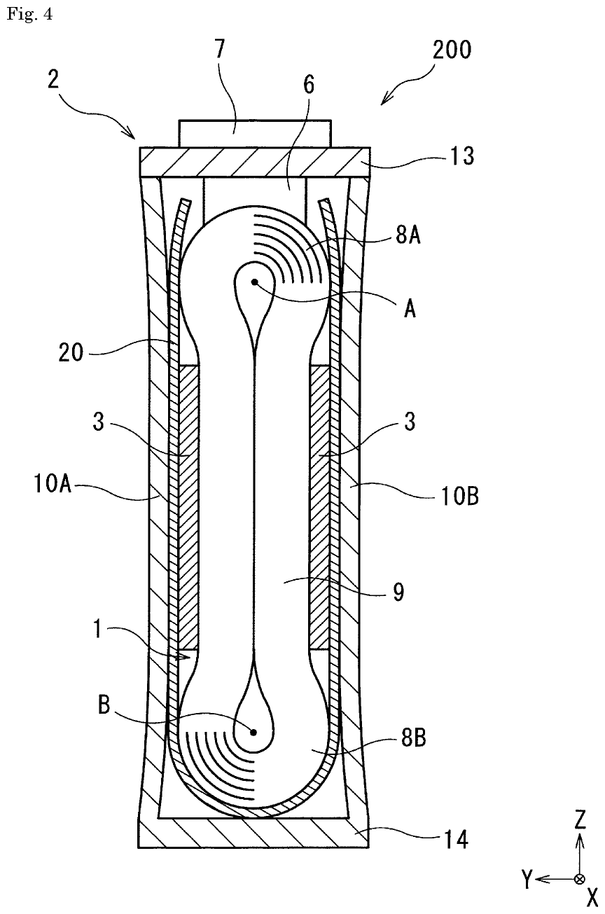

An energy storage device 200 (secondary battery) according to a second embodiment of the present invention illustrated in FIG. 4 mainly includes an electrode assembly 1, a case 2, two sheet-like members 3, an insulating member 20, and an electrolyte (not illustrated). The energy storage device 200 is similar to the energy storage device 100 except that the case 2 (case body 14) is made of metal and the insulating member 20 is further included as compared with the energy storage device 100. Accordingly, in the energy storage device 200, constituents other than the insulating member 20 are denoted by the same reference numerals as those of the energy storage device 100 in FIGS. 1 and 2, and a detailed description thereof is omitted.

The insulating member 20 covers the electrode assembly 1 and electrically insulates the electrode assembly 1 from the case 2. In the energy storage device 200, the sheet-like member 3 is disposed between the electrode assembly 1 and the insulating member 20. Specifically, the insulating member 20 has a bag-like structure. The insulating member 20 covers the electrode assembly 1 except for an end (upper end in FIG. 4) of the electrode assembly 1 on the lid 13 side. The material of the insulating member 20 is not particularly limited as long as it is electrically insulating (non-conductive), and for example, polyolefin such as polyethylene and polypropylene, resin such as polyimide and polyamide, and the like can be used.

The sheet-like member 3 is in contact with an inner surface of the bag-like insulating member 20. The sheet-like member 3 of the energy storage device 200 is also in contact with only a flat portion 9 with respect to the electrode assembly 1, and is not in contact with curved surface portions 8A and 8B. On the other hand, the insulating member 20 may be in contact with the curved surface portions 8A and 8B of the electrode assembly 1. In the present embodiment, it is preferable that the sheet-like member 3 and the insulating member 20 are bonded to each other, and it is more preferable that the sheet-like member 3 and the insulating member 20 are bonded to each other by thermal welding. In the case of bonding by thermal welding, the sheet-like member 3 and the insulating member 20 are preferably made of the same material, and from the viewpoint of strength and ease of handling, both are more preferably made of polypropylene.

Also in the energy storage device 200 including the insulating member 20 thus configured, there is exhibited an effect that it is possible to suppress a load applied to the curved surface portions 8A and 8B of the electrode assembly 1 and to apply a relatively large load to the flat portion 9. In the energy storage device 200, since the sheet-like member 3 is bonded to the inner surface of the insulating member 20, the sheet-like member 3 is hardly displaced, and a load can be applied to a designed position with high reliability. Thus, the energy storage device 200 is also excellent in productivity.

The energy storage device 200 can be produced by a production method including, for example, fabricating a wound flattened electrode assembly, preparing a bag-like insulating member in which a sheet-like member is bonded to a predetermined position on an inner surface, inserting the electrode assembly into the bag-like insulating member, housing the insulating member in a state in which the electrode assembly is inserted in a case, injecting an electrolyte into the case, and hermetically sealing the case.

### <Configuration of Nonaqueous Electrolyte Solution Energy Storage Apparatus>

The energy storage device of the present embodiment can be mounted as an energy storage unit (battery module) configured by assembling a plurality of energy storage devices on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique according to an embodiment of the present invention may be applied to at least one energy storage device included in the energy storage unit.

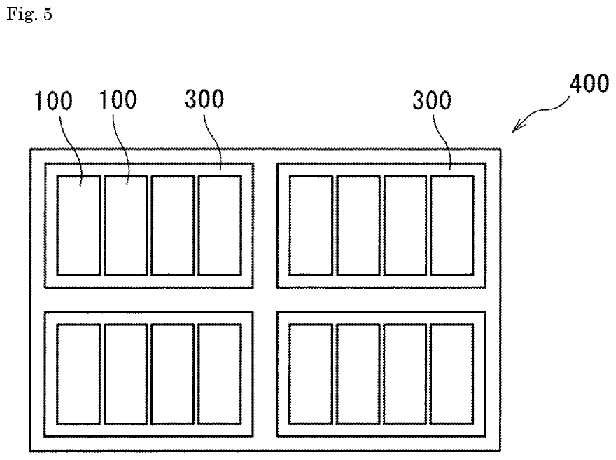

FIG. 5 illustrates an example of an energy storage apparatus 400 formed by assembling energy storage units 300 in each of which two or more electrically connected energy storage devices 100 are assembled. The energy storage apparatus 400 may include a busbar (not illustrated) for electrically connecting the two or more energy storage devices 100, a busbar (not illustrated) for electrically connecting the two or more energy storage units 300, and the like. The energy storage unit 300 or the energy storage apparatus 400 may include a state monitor (not illustrated) for monitoring the state of one or more energy storage devices. The energy storage device 100 may be the energy storage device 200 according to the second embodiment of the present invention.

### Other Embodiments

The present invention is not limited to the above embodiments, and various modifications may be made without departing from the gist of the present invention. For example, to the configuration of an embodiment, the configuration of another embodiment can be added, and a part of the configuration of an embodiment can be replaced by the configuration of another embodiment or a well-known technique. Furthermore, a part of the configuration according to one embodiment can be removed. In addition, a well-known technique can be added to the configuration according to one embodiment.

In the above embodiment, the sheet-like member is disposed on each of both surfaces of the flat portion, but may be disposed only on one surface side. However, by disposing the sheet-like member on each of both surfaces, an effect that it is possible to suppress a load on the curved surface portion of the electrode assembly and to apply a relatively large load to the flat portion of the electrode assembly can be further enhanced.

In the above embodiment, although the case where the energy storage device is used as a chargeable and dischargeable secondary battery (for example, lithium ion secondary battery) has been described, the type, size, capacity, and the like of the energy storage device are arbitrary. The energy storage device according to the present invention can also be applied to capacitors such as electric double layer capacitors and lithium ion capacitors, energy storage devices in which an electrolyte other than nonaqueous electrolytes is used, and the like.

### EXAMPLES

Hereinafter, the present invention will be described in more detail with reference to examples, but the present invention is not limited to the following examples.

### Examples 1 to 3, Comparative Examples 1 and 2

### (Fabrication of Electrode Assembly)

The belt-like positive electrode and the belt-like negative electrode were stacked on one another with the belt-like separator interposed therebetween, and wound in the longitudinal direction to fabricate a flattened electrode assembly. The obtained electrode assembly had a thickness T of 11.3 mm, a length H (length in the Z direction) of 57.4 mm, and a length L (length in the Z direction) of the flat portion of 46.2 mm.

### Preparation of Sheet-Like Member

A sheet-like member having a rectangular shape in plan view with a length X (length in the Z direction), a width (length in the X direction) of 115 mm, and a thickness of 0.15 mm described in Table 1 was prepared. A width (length in the X direction) of the sheet-like member was substantially equal to the width (length in the X direction) of the electrode assembly. As all of the sheet-like members, a member made of polypropylene was prepared.

### (Evaluation)

In order to simulate the load applied to the electrode assembly by bringing the inside of the case into the negative pressure state, the number of the sheet-like members shown in Table 1 was arranged on the electrode assembly placed on an aluminum plate, and a pressure-sensitive sensor was disposed thereon. The arrangement was performed such that the length direction of the sheet-like member coincided with the length direction of the electrode assembly, and such that a center position of the electrode assembly coincided with a center position of the sheet-like member in plan view. In Comparative Example 1, the pressure-sensitive sensor was disposed directly on the electrode assembly without disposing the sheet-like member. Table 1 shows the distance Y from both ends of the flat portion to both ends of the sheet-like member and a ratio of a total thickness of the sheet-like member to the thickness of the electrode assembly in Examples 1 to 3 and Comparative Example 2, and shows a magnitude relationship between Y and T/2 (=5.65 mm), a magnitude relationship between Y and 0.1 L (=4.6 mm), and a magnitude relationship between Y and 0.2 L (=9.2 mm) in Examples 1 to 3. The “distance Y from both ends of the flat portion to both ends of the sheet-like member” is indicated as “+” when both ends of the sheet-like member are located inside both ends of the flat portion, and is indicated as “−” when both ends of the sheet-like member are located outside both ends of the flat portion.

Next, the aluminum plate was disposed on the pressure-sensitive sensor, and a load was applied to the upper aluminum plate from above. The two aluminum plates and the pressure-sensitive sensor were sufficiently larger than the side surface of the electrode assembly. The load was applied using a universal tester “Autograph” (model number: AG-X) manufactured by Shimadzu Corporation. The load was applied until a width of a central slit of the electrode assembly reached 0.1 mm, and the load applied to the curved surface portion and the load applied to the flat portion were obtained based on a value output by the pressure-sensitive sensor at that time. In the pressure-sensitive sensor used, since the load was output for each area of 2.54 mm×2.54 mm, a total value of the load in a portion corresponding to the curved surface portion and a total value of the load in a portion corresponding to the flat portion were defined as a curved surface portion load and a flat portion load, respectively. The measurement results are shown in Table 1. Table 1 also shows a ratio of the curved surface portion load to a sum of the curved surface portion load and the flat portion load (curved surface portion load ratio (%)) and a ratio of the flat portion load to the sum of the curved surface portion load and the flat portion load (flat portion load ratio (%)).

TABLE 1

| | | Comparative | Comparative | | | |
|---|---|---|---|---|---|---|
| | | Example 1 | Example 2 | Example 1 | Example 2 | Example 3 |
| Sheet-like member | Length X (length in | — | 57 | 25 | 30 | 40 |
| | Z direction)/mm | | | | | |
| | The number/sheet | 0 | 3 | 3 | 3 | 2 |

| | | | | | |
|---|---|---|---|---|---|
| Distance Y from both ends of flat portion to both | — | −5.4 | +10.6 | +8.1 | +3.1 |
| ends of sheet-like member/mm * | | | | | |
| Magnitude relationship between Y and T/2 (=5.65) | — | — | Y > T/2 | Y > T/2 | Y < T/2 |
| Magnitude relationship between Y and 0.1 L (=4.6) | — | — | Y > 0.1 L | Y > 0.1 L | Y < 0.1 L |
| Magnitude relationship between Y and 0.2 L (=9.2) | — | — | Y > 0.2 L | Y < 0.2 L | Y < 0.2 L |
| Ratio of total thickness of sheet-like member to | — | 0.040 | 0.040 | 0.040 | 0.027 |
| thickness of electrode assembly | | | | | |
| Curved surface portion load/N | 332 | 292 | 78 | 69 | 144 |
| Flat portion load/N | 137 | 126 | 75 | 87 | 108 |
| Curved surface portion load ratio/% | 71 | 70 | 51 | 44 | 57 |
| Flat portion load ratio/% | 29 | 30 | 49 | 56 | 43 |

* “+” indicates that both ends of sheet-like member are located inside both ends of flat portion, and “−” indicates that both ends of sheet-like member are located outside both ends of flat portion.

In Comparative Example 1 in which the sheet-like member was not disposed, a large load was applied to the curved surface portion. Also in Comparative Example 2 in which the length X (length in the Z direction) of the sheet-like member was longer than the length H (46.2 mm) of the flat portion and the sheet-like member was also in contact with the curved surface portion, a large load was applied to the curved surface portion as in Comparative Example 1, and an improvement effect obtained by disposing the sheet-like member was not observed.

On the other hand, in Examples 1 to 3 in which the length X (length in the Z direction) of the sheet-like member was shorter than the length H (46.2 mm) of the flat portion and the sheet-like member was in contact only with the flat portion, the load on the curved surface portion was weakened, and the load ratio on the flat portion could be increased. In comparison among Examples, the load ratio on the flat portion in Example 2 was high as compared with Example 1 in which the length X (length in the Z direction) of the sheet-like member was relatively short and Example 3 in which the length X was relatively long. It can be seen that the load ratio on the flat portion can be further increased when the length X of the sheet-like member is a suitable length, that is, when the distance Y from both ends of the flat portion to both ends of the sheet-like member is a suitable length.

### INDUSTRIAL APPLICABILITY

The present invention can be applied to a nonaqueous electrolyte energy storage device used as a power source for automobiles, other vehicles, electronic devices, and the like.

### DESCRIPTION OF REFERENCE SIGNS

100, 200: energy storage device
1: electrode assembly
2: case
3: sheet-like member
4: positive electrode connecting member
5: positive electrode external terminal
6: negative electrode connecting member
7: negative electrode external terminal
8A, 8B: curved surface portion
9: flat portion
10A, 10B: side wall
11A, 11B: both ends of curved surface portion
12A, 12B: both ends of flat portion
13: lid
14: case body
20: insulating member
A, B: axis
300: energy storage unit
400: energy storage apparatus

1. An energy storage device comprising:
a flattened electrode assembly formed by winding a belt-like electrode in a longitudinal direction thereof and including two curved surface portions and a flat portion located between the two curved surface portions;
a case housing the electrode assembly; and
a sheet-like member disposed between the electrode assembly and the case,
wherein
when an inside of the case is in a negative pressure state, the electrode assembly is in a state of being pressed by the case with the sheet-like member interposed therebetween, and
the sheet-like member is in contact only with the flat portion with respect to the electrode assembly.

2. The energy storage device according to claim 1, wherein when a thickness of the electrode assembly is defined as T, both ends of the sheet-like member in an opposing direction of the two curved surface portions are present in a range inside a position on a T/2 inner side from both ends of the flat portion on a side of the two curved surface portions.

3. The energy storage device according to claim 1, wherein when a length in the opposing direction of the two curved surface portions of the flat portion is defined as L, both ends of the sheet-like member in the opposing direction of the two curved surface portions are present in a range inside a position on a 0.1 L inner side from both ends of the flat portion on a side of the two curved surface portions.

4. The energy storage device according to claim 1, wherein when the length in the opposing direction of the two curved surface portions of the flat portion is defined as L, both ends of the sheet-like member in the opposing direction of the two curved surface portions are each present in a range outside a position on a 0.2 L inner side from both ends of the flat portion on the side of the two curved surface portions.

5. The energy storage device according to claim 1, wherein a ratio of a thickness of the sheet-like member to the thickness of the electrode assembly is 0.030 or more.

6. The energy storage device according to claim 1, wherein
the case includes metal,
the energy storage device comprises an insulating member which covers the electrode assembly and insulates the electrode assembly and the case from each other, and
the sheet-like member is disposed between the electrode assembly and the insulating member.
